(19) United States
(12) Patent Application Publication
(10) Pub. No.: US 2025/0165888 A1
(43) Pub. Date: May 22, 2025

(54) SOLAR ENERGY MANAGEMENT SYSTEM AND METHOD

(71) Applicant: Havenergy Consulting, Inc., Guilderland, NY (US)

(72) Inventor: Adewale Adesanya, Guilderland, NY (US)

(73) Assignee: Havenergy Consulting, Inc., Guilderland, NY (US)

(21) Appl. No.: 18/955,081

(22) Filed: Nov. 21, 2024

Related U.S. Application Data
(60) Provisional application No. 63/601,563, filed on Nov. 21, 2023.

(51) Int. Cl. G06Q 10/0631; G06Q 30/018; G06Q 50/06

(52) U.S. Cl. CPC G06Q 10/06315; G06Q 30/018; G06Q 50/06

(57) ABSTRACT

A computer implemented method for managing and optimizing solar energy consumption of a user includes retrieving weather data over a predetermined time period from weather resources connected to the internet. Solar energy generation ratings of a solar energy system of a user are obtained. A solar energy peak generation profile over the predetermined time period is forecast for the solar energy system. Energy consumption ratings of a plurality of devices used by the user are obtained that are powered by the solar energy system. An energy consumption pattern of the user's use of the plurality of devices over the predetermined time period is determined. One or more offshoots of the energy consumption pattern are predicted to occur. The one or more offshoots of the energy consumption pattern are avoided by modifications of the user's use of a set of devices of the plurality of devices during the predetermined time period.

### CROSS REFERENCE TO RELATED APPLICATIONS

This application is a non-provisional application of, and claims the benefit of the filing date of, U.S. provisional application 63/601,563, filed Nov. 21, 2023, entitled: “ADEXEAC ENERGY MANAGEMENT AND ADVISORY SYSTEM,” the contents of which are incorporated herein by reference in their entirety.

### TECHNICAL FIELD

The present disclosure relates to energy management systems and methods of making the same. More specifically, the disclosure relates to systems and methods for managing and optimizing solar energy consumption.

### BACKGROUND

Existing energy management systems generally provide users with charts and tables of energy consumption performance by a user, with little advice or mechanisms directed to improving that performance. They also lack mechanisms to reinforce sustainable behavioral changes around energy consumptions such as spurring timely or proactive actions by users. Additionally, current energy management systems are not dedicated solely to managing solar energy systems.

Moreover, current energy management systems have many technical limitations when it comes to management of solar energy systems, that can lead to significant cost overruns. For example, current energy management systems do not typically forecast the peak of photovoltaic generation capabilities of a given solar energy system for any given time period, which may vary significantly due to current weather conditions. Further, such prior art systems do not determine energy consumption patterns in real-time of a user and provide guidance as to how to modify those energy consumption patterns to best match the forecasted peak and off peak solar energy generation profile of any given time period.

In another example, current energy management systems do not predict, nor provide guidance, on how to avoid offshoots, wherein the energy consumption pattern will exceed the forecasted solar energy peak generation profile. Also, by way of example, current energy management systems do not predict, during any given time period, when one or more energy consumption peaks of the energy consumption pattern will occur; while providing guidance on how to reduce (or peak shave) those peaks.

The above described technical limitations of current energy management systems, can lead to significant and needless energy cost overruns. Additionally, these technical limitations can result in the wasteful generation of carbon dioxide (CO2) emissions and users being more dependent on additional energy sources like the grid or battery.

Accordingly, there is a need for systems and methods for managing and optimizing solar energy consumption of energy generated from a solar energy system that best fits the consumption pattern of a user to the forecasted solar energy peak generation profile of the solar energy system, to result in the technical advantage over the prior art of increased energy cost savings and reduced CO2 emissions. There is also a need for solar energy management systems and methods that provide guidance on how to avoid offshoots of a user's consumption pattern over that of the peak solar generation capabilities of a solar energy system for increased cost savings and reduced CO2 emissions. There is also a need for solar energy management systems and methods that provide guidance on how to reduce (i.e., peak shave) energy consumption peaks of an energy consumption pattern for increased cost savings and reduced CO2 emissions.

### BRIEF DESCRIPTION OF THE INVENTION

The present disclosure offers technical advantages and alternatives over the prior art by providing systems and methods that manage and optimize solar energy consumption of a user for optimal cost savings and reduce CO2 emissions through deliberate and intentional user behavioral changes. The systems and methods are advantageously capable of forecasting a solar energy peak generation profile over a predetermined time period (for example, over a day) for a solar energy system based on real time and forecasted weather data and solar energy generation ratings of the solar energy system. The system and methods may determine an energy consumption pattern of a user's use of a plurality of devices powered by the solar energy system over the predetermined time period. The systems and methods may predict, during the predetermined time period, when offshoots of the energy consumption pattern will occur and proactively avoid the predicted offshoots by modifications of the user's use of a first set of devices of the plurality of devices. The avoidance of the predicted offshoots may result in a reduction of energy consumption costs and a reduction in CO2 emissions.

The systems and methods may also advantageously predict, during the predetermined time period, when energy consumption peaks of the energy consumption pattern will occur. The systems and methods may reduce the energy consumption peaks by modifications of the user's use of a second set of devices of the plurality of devices during the predetermined time period. The reduction of the energy consumption peaks may result in a further reduction of energy consumption costs and a further reduction in CO2 emissions.

A computer implemented method for managing solar energy consumption of a user in accordance with one or more aspects of the present disclosure includes retrieving weather data over a predetermined time period from weather resources connected to the internet. Solar energy generation ratings of a solar energy system of a user are obtained. A solar energy peak generation profile is forecasted over the predetermined time period for the solar energy system based on the weather data and the solar energy generation ratings. Energy consumption ratings of a plurality of devices used by the user that are connected to, and powered by, the solar energy system are obtained. An energy consumption pattern of the user's use of the plurality of devices over the predetermined time period is determined. During the predetermined time period, it is predicted when one or more offshoots of the energy consumption pattern will occur, wherein the energy consumption pattern will exceed the forecasted solar energy peak generation profile. The one or more offshoots of the energy consumption pattern are avoided by first modifications of the user's use of a first set of devices of the plurality of devices during the predetermined time period. The avoidance of the one or more offshoots results in a reduction of energy consumption costs or a reduction in CO2 emissions.

The computer implemented method may also predict, during the predetermined time period, when one or more energy consumption peaks of the energy consumption pattern will occur. The one or more energy consumption peaks of the energy consumption pattern are reduced by second modifications of the user's use of a second set of devices of the plurality of devices during the predetermined time period. The reduction of the one or more consumption peaks results in a further reduction of energy consumption costs or a further reduction in CO2 emissions.

A computer system for managing solar energy consumption of a user in accordance with one or more aspects of the present disclosure includes at least one memory. One or more processors are in communication with the at least one memory. The computer system is configured to perform a method. The method includes retrieving weather data over a predetermined time period from weather resources connected to the internet. Solar energy generation ratings of a solar energy system of a user are obtained. A solar energy peak generation profile is forecasted over the predetermined time period for the solar energy system based on the weather data and the solar energy generation ratings. Energy consumption ratings of a plurality of devices used by the user that are connected to, and powered by, the solar energy system are obtained. An energy consumption pattern of the user's use of the plurality of devices over the predetermined time period is determined. During the predetermined time period, it is predicted when one or more offshoots of the energy consumption pattern will occur, wherein the energy consumption pattern will exceed the forecasted solar energy peak generation profile. The one or more offshoots of the energy consumption pattern are avoided by first modifications of the user's use of a first set of devices of the plurality of devices during the predetermined time period. The avoidance of the one or more offshoots results in a reduction of energy consumption costs or a reduction in CO2 emissions.

The computer system may also predict, during the predetermined time period, when one or more energy consumption peaks of the energy consumption pattern will occur. The one or more energy consumption peaks of the energy consumption pattern are reduced by second modifications of the user's use of a second set of devices of the plurality of devices during the predetermined time period. The reduction of the one or more energy consumption peaks results in a further reduction of energy consumption costs or a further reduction in CO2 emissions.

A computer system product for managing solar energy consumption of a user in accordance with one or more aspects of the present disclosure includes at least one computer readable storage medium readable by a processing circuit and storage instructions for performing a method. The method includes retrieving weather data over a predetermined time period from weather resources connected to the internet. Solar energy generation ratings of a solar energy system of a user are obtained. A solar energy peak generation profile is forecasted over the predetermined time period for the solar energy system based on the weather data and the solar energy generation ratings. Energy consumption ratings of a plurality of devices used by the user that are connected to, and powered by, the solar energy system are obtained. An energy consumption pattern of the user's use of the plurality of devices over the predetermined time period is determined. During the predetermined time period, it is predicted when one or more offshoots of the energy consumption pattern will occur, wherein the energy consumption pattern will exceed the forecasted solar energy peak generation profile. The one or more offshoots of the energy consumption pattern are avoided by first modifications of the user's use of a first set of devices of the plurality of devices during the predetermined time period. The avoidance of the one or more offshoots results in a reduction of energy consumption costs or a reduction in CO2 emissions.

The computer system product may also predict, during the predetermined time period, when one or more energy consumption peaks of the energy consumption pattern will occur. The one or more energy consumption peaks of the energy consumption pattern are reduced by second modifications of the user's use of a second set of devices of the plurality of devices during the predetermined time period. The reduction of the one or more energy consumption peaks results in a further reduction of energy consumption costs or a further reduction in CO2 emissions.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits and advantages described herein.

### BRIEF DESCRIPTION OF THE DRAWINGS

The disclosure will be more fully understood from the following detailed description taken in conjunction with the accompanying drawings, in which:

FIG. 1 depicts an example of a computer implemented method for managing solar energy consumption of a user, wherein the computer system is providing advice on avoiding an offshoot, according to aspects described herein;

FIG. 2 depicts an example of the computer system of FIG. 1, wherein the computer implemented method is providing advice on reducing energy consumption peaks in an energy consumption pattern, according to aspects described herein;

FIG. 3 depicts an example of a flow diagram of a computer implemented method for managing solar energy consumption of a user, according to aspects described herein;

FIG. 4 depicts an example of a flow diagram of a continuation of the computer implemented method of FIG. 3, according to aspects described herein; and

FIG. 5 depicts an example of a computing environment which may be used to incorporate and perform one or more aspects of a method for managing solar energy consumption of a user, in accordance with aspects described herein.

### DETAILED DESCRIPTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example may be combined with the features of other examples. Such modifications and variations are intended to be included within the scope of the present disclosure.

The terms “significantly”, “substantially”, “approximately”, “about”, “relatively,” or other such similar terms that may be used throughout this disclosure, including the claims, are used to describe and account for small fluctuations, such as due to variations in processing from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

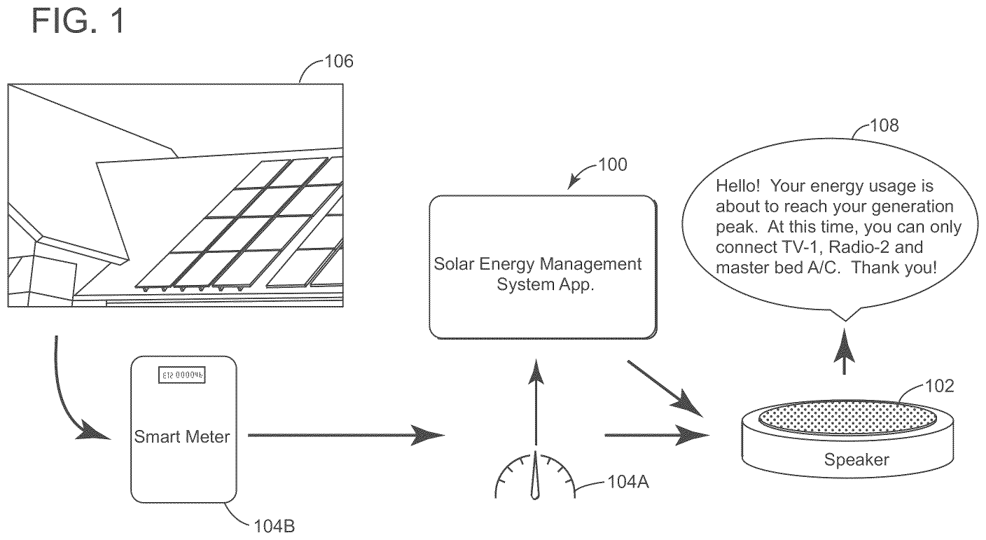

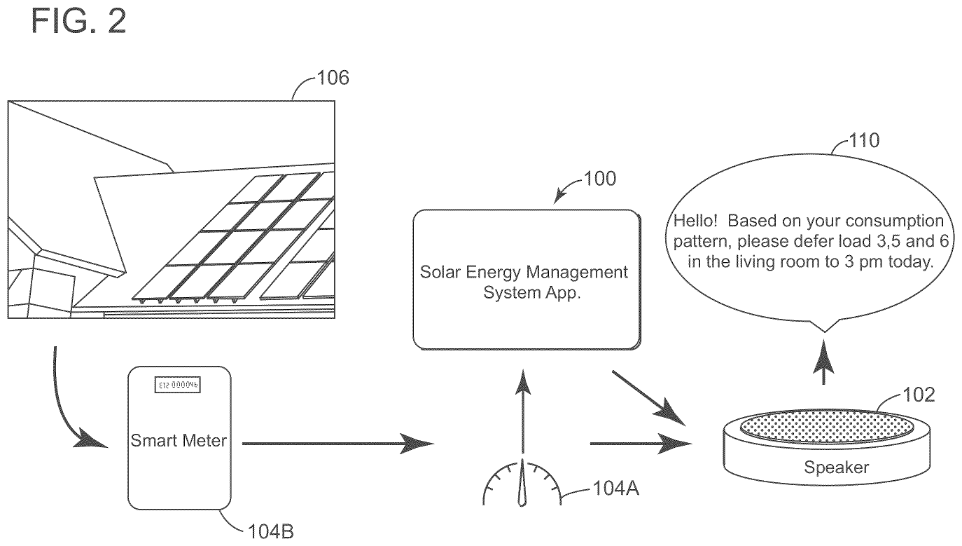

Referring to FIGS. 1 and 2, an example is depicted of a computer implemented method 100 for managing solar energy consumption of a user, wherein the computer implemented method 100 is providing advice on avoiding an offshoot (FIG. 1) and providing advice on reducing energy consumption peaks in an energy consumption pattern (FIG. 2), according to aspects described herein. In the example depicted in FIGS. 1 and 2, the computer implemented method 100 is in the form of a computer application (also known as an “App.”) and may be referred to herein as App. 100.

App. 100 is a software program designed to carry out the specific tasks related to managing solar energy consumption of a user (not shown). The App. 100 may be run on a computer system or may be stored on a computer system product.

The computer system includes at least one memory and one or more processors in communication with the at least one memory. The computer system may be configured to perform the computer implemented method or App. 100.

The computer system product includes at least one computer readable storage medium on which the App. 100 may be stored. The storage medium of the computer system product is readable by a processing circuit and has storage instructions for performing the computer implemented method or App. 100.

The computer implemented method or App. 100 provides an audio-visual energy solution. The App. 100 provides an interactive energy management, information, and advisory system that can help homeowners or commercial outfits (i.e., users) with solar photo voltaic (PV) energy generation to track, manage, and maintain daily PV energy consumption, matching the user's load with solar PV generation of a solar energy system used by the user.

The App. 100 may be software integrated with a speaker device 102, such as an echo smart speaker device 102, which interacts with an electric meter 104A, or smart meter 104B, and home or commercial solar energy systems 106 to provide users (not shown) real time information about their current energy usage in relation to their solar PV generation.

The computer implemented method 100 or App. 100 may run on artificial intelligence with configurations that allow flow of real time generation-load tracking reports. The App. 100 may communicate potential consumption offshoots (an offshoot being the energy consumption of a user that exceeds the PV energy generation capacity of a solar energy system 106 used by the user (not shown)). The App. 100 may provide advice on avoiding offshoots 108 (see FIG. 1) or on reducing peak shaving 110 (see FIG. 2). The advice may be provided via, for example, the speaker device 102 and/or a mobile phone system (not shown) and be reported or displayed on the App. 100.

The App. 100, of other forms of the invention, advantageously helps to reduce PV energy consumption costs and CO2 emissions. For example, for an average residential user of a solar energy system with a daily PV energy consumption of 25 kilowatt-hours per day (kWh/day) may advantageously achieve a reduction of up to 32 pounds of CO2 emissions and up to 35% energy cost savings without investment in additional costly energy efficiency devices. This technical advantage provided by the App. 100 is does not exist in prior art energy management systems.

The App. 100, or other embodiments of the invention, may provide an audio-visual energy solution that is geared towards driving/enforcing/supporting/promulgating behavioral changes of solar photovoltaic (PV) energy users (residential and commercial) in an environmentally friendly, economical, and social sustainable manner. The App. 100 may leverage artificial intelligence to optimize, manage and improve energy consumption in residential and commercial solar generation through a combined real time audio-visual notification system that forces proactive behavioral changes in a user that results in energy consumption cost savings and reductions in CO2 emissions. The App. 100 may provide an interactive energy management system that will help homeowners and commercial outfits to optimize solar photovoltaic (PV) energy utilization by tracking and managing daily energy consumption and matching their loads to solar PV generation of a user's solar energy system. The App. 100 software application may have a corresponding hardware component that will provide users with combined audio and visual, real-time information on potential energy consumption overshoot and advice on peak shaving with respect to their solar energy generation.

The App. 100 may include such features as:

Supporting a user in peak shaving and optimizing solar production capacity.

Minimizing energy waste and demand.

Providing audio and visual proactive start of the day predictions and advisory reports.

Providing audio and visual real time reports on energy usage in relation to solar energy generation.

Enabling and prompting the entry of all current home or office devices and their energy ratings and their locations (e.g., bedroom 1, living room, pump house, office 1, etc.).

Providing energy consumption threshold settings and offshoot warnings for energy generated from solar energy systems.

Providing energy consumption threshold settings and cost offshoot warning for energy generated from the grid and/or other energy sources (such as from wind energy generation systems).

Providing voice reports (in multiple languages) via smart speaker on production and consumption levels.

Providing via smart speaker advice on devices to add or remove to avoid offshoot or reduce energy consumption peaks.

Providing daily, monthly, yearly, and lifetime reports.

Forecasting solar energy production using weather forecast data retrieved from the internet.

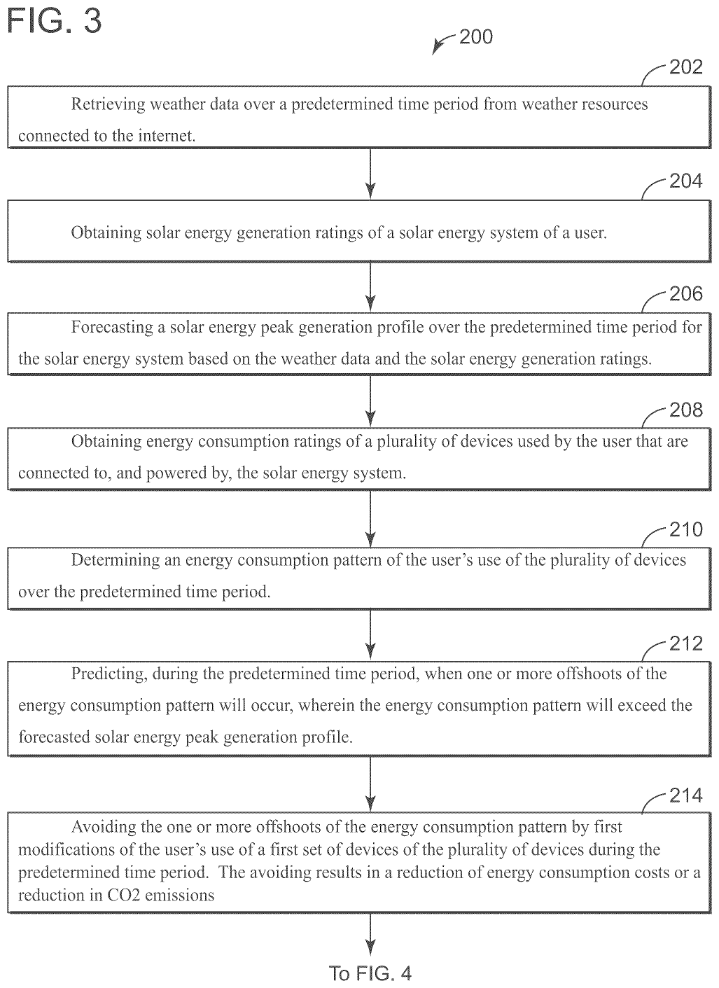

Referring to FIG. 3 an example is depicted of a flow diagram of a computer implemented method 200 for managing and optimizing solar energy consumption of a user (not shown), according to aspects described herein.

The method 200 may start at 202 with retrieving weather data over a predetermined time period from weather resources connected to the internet. The weather data may include data from the national weather service or other open source weather resources. The predetermined time period may be any appropriate time period applicable to the specific needs of a user. Additionally, the user may set the predetermined time period or the predetermined time period may have a default setting, such as, for example, a day. The predetermined time period may be, for example, an hour, a half day, a day or a week.

The weather data may be obtained from a weather data API (Application Programming Interface) service, which is a service that allows developers to access and integrate real-time weather information like temperature, humidity, wind speed, precipitation, and forecasts from various sources into their applications and websites, providing users with current and predicted weather conditions for specific locations. Essentially, weather data API is a service that pulls weather data directly into a software program through a set of protocols and tools. The weather data may specifically be for the region where a user's solar energy system is located.

At 204, solar energy generation ratings of a solar energy system of a user are obtained. This data may be obtained from several sources in a variety of ways. For example, the ratings may be input directly by a user into the App. 100. Alternatively, by way of example, the solar energy generation ratings may be obtained from the manufacturer or installer of the solar energy system via the internet or may be input directly into the App. 100 by personnel from the manufacturer or installer.

At 206, a solar energy peak generation profile may be forecasted over the predetermined time period for the solar energy system based on the weather data and the solar energy generation ratings. Since the weather will vary over time, the output of a solar energy system may not always be at its maximum capacity. For example, the weather over a solar energy system may be cloudy, wherein the solar energy peak generation profile will be significantly less than what it would be on a sunny day.

Moreover, there will likely be variations of weather during the predetermined time period, which will affect the output capacity of the solar energy system. The forecasted solar energy peak generation profile may take these factors into account. Additionally, the forecasted solar energy peak generation profile may be adjusted as weather conditions deviate from that of the forecasted weather during the predetermined time period.

Moreover, the forecasted solar energy peak generation profile may also be adjusted if certain components of the solar energy system deviate from their maximum ratings. For example, a solar panel may get covered with debris or dirt, or a solar panel may cease to function altogether during the predetermined time period. The solar energy peak generation profile may be adjusted to account for these changes in real time.

At 208, energy consumption ratings of a plurality of devices used by the user that are connected to, and powered by, the solar energy system may be obtained. Again, the energy production ratings of these devices may be obtained in a variety of ways. For example, the device ratings may be input directly into the App. 100 by the user. Alternatively, they may be obtained via the internet from the manufacturer or input directly into the App. 100 by personnel from the manufacturer. Additionally, the App. 100 may be connected to sensors that monitor the performance of the devices connected to the solar energy system and may adjust the ratings of any particular device that begins to under perform or malfunction.

At 210, an energy consumption pattern of the user's use of the plurality of devices over the predetermined time period may be determined. This consumption pattern may initially be an estimate that is input by the user or others. However, the App. 100 may use Artificial Intelligence (AI) techniques and tools (such as machine learning, large language modeling, and natural language processing) to improve the determination of the pattern over time. Additionally, the App. 100 may adjust the consumption pattern as a user's habits change or as new devices are added or removed from the solar energy system.

Moreover, the devices may not be connected solely to the solar energy system. The devices may be powered by a mix of energy sources, such as, for example, from the solar energy system, electrical energy from the electrical grid, or wind power energy.

At 212, during the predetermined time period, the App. 100 may predict when one or more offshoots of the energy consumption pattern will occur, wherein the energy consumption pattern will exceed the forecasted solar energy peak generation profile. The App. 100 may predict that according to the energy consumption pattern of a user, it is highly likely that the capacity of the solar energy system will be exceeded during an upcoming hour of a 24 hour predetermined time period, due to the electrical loads of certain first set of devices that are normally active at the upcoming hour.

At 214, the one or more offshoots of the energy consumption pattern may be avoided by first modifications of the user's use of the first set of devices of the plurality of devices during the predetermined time period. The avoidance of the one or more offshoots advantageously results in a reduction of energy consumption costs and/or a reduction in CO2 emissions.

Avoiding the one or more offshoots may be accomplished in several ways. For example, the user's use of the first set of devices may be prohibited when the one or more offshoots are predicted to occur. Alternatively, the use of the first set of devices may be shifted to a portion of the predetermined time period wherein the use of the first set of devices will not cause an offshoot that exceeds the solar energy peak generation profile.

The prohibiting of the use of the first set of devices may be done automatically, by the App. 100 sending out a disconnect signal to those devices which will disconnect the first set of devices from the solar energy system. However, prior to App. 100 sending a disconnect signal, the App. 100 may notify the user that a disconnect signal to automatically disconnect the first set of devices from the solar energy system is about to be generated, in order to give the user an opportunity to override the disconnect signal. In other word, the App. 100 may provide a means for enabling the user to decide to use the first set of devices in spite of the predicted offshoot. For example, the user may be relying on the grid, as well as the solar energy system to power the first set of devices. In that case, the user may decide that it is important to keep those devices functioning even if an offshoot of the solar energy system will occur, because the user can use the more expensive electrical energy from the grid to make up for the offshoot.

Accordingly, if the user decides not to disconnect the first set of devices, then the user may generate, or initiate, a first user implemented override signal, which will effectively override the generation of the disconnect signal. In other words, the user implemented first override signal would prevent the App. 100 from sending a disconnect signal and keep the first set of devices functioning during the predicted offshoot period.

However, the user may decide not to generate the first user implemented override signal. In that case the disconnect signal will be generated by the App. 100 to disconnect the first set of devices during the predicted offshoot period.

Alternatively, rather than generating a first user implemented override signal, the App. 100 may prohibit the use of the first set of devices by simply advising the user to manually disconnect the first set of devices from the solar energy system when the one or more offshoots are predicted to occur. This is the example depicted in FIG. 1, wherein a speaker 102 connected to the App. 100 verbally indicates at 108 that the first set of devices should be turned off, because the energy usage is about to reach the peak generation capacity of the solar energy system.

In the example illustrated in FIG. 1, the first set of devices include TV-1, radio-2 and the master bed air conditioning system. However, any number of devices that are connected to the solar energy system may be included in the first set of devices.

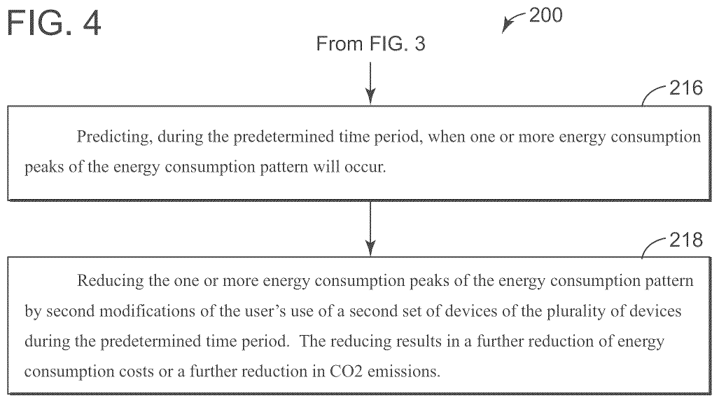

Referring to FIG. 4, an example is depicted of a flow diagram of a continuation of the computer implemented method 200 of FIG. 3, according to aspects described herein. The method 200 may continue at 216, by predicting, during the predetermined time period, when one or more energy consumption peaks of the energy consumption pattern will occur. The energy consumption peaks may not be offshoots. Rather the energy consumption peaks may be within the forecasted solar energy peak generation profile of the solar energy system. However, the user may be using both energy from the grid as well as energy from the solar energy system to meet the user's energy needs. In that case, the energy consumption peaks may occur during peak demand periods of the grid, wherein energy supplied by the grid is most expensive. Accordingly, reducing the energy consumption peaks by, for example, shifting the time of use of a second set of devices of the plurality of devices that are connected to the solar energy system and to the grid, would advantageously save cost.

Moreover, if by shifting the time of usage of the second set of devices, the second set of devices is powered by a greater percentage of energy from the solar energy system and a smaller percentage of energy from the grid, then the reduction in the energy consumption peaks may also advantageously provide the technical advantage of reducing CO2 emissions. This shifting to effectively increase the percentage of solar energy, and decrease the percentage of grid energy, supplied to the second set of devices in order to reduce CO2 emissions may be automatically calculated and adjusted or advised by the App. 100.

At 218, the one or more energy consumption peaks of the energy consumption pattern may be reduced by second modifications of the user's use of the second set of devices of the plurality of devices during the predetermined time period. As discussed earlier herein, the reduction of the one or more energy consumption peaks may result in a further reduction of energy consumption costs and/or a further reduction in CO2 emissions.

Reducing the one or more energy consumption peaks may be accomplished in several ways. For example, the time of the user's use of the second set of devices during the predetermined time period may be shifted, such that the second set of devices are not used when the one or more energy consumption peaks are predicted to occur. Alternatively, the user's use of the second set of devices may be prohibited when the one or more offshoots are predicted to occur.

The shifting of the time of use of the second set of devices may be done automatically, by, for example, the App. 100 sending out a shift signal to those devices in the second set, which will shift the time of use of the second set of devices. However, prior to App. 100 sending a shift signal, the App. 100 may notify the user that a shift signal to automatically shift the time of use of the second set of devices during the predetermined time period is about to be generated, in order to give the user an opportunity to override the shift signal. In other words, the App. 100 may provide a means for enabling the user to decide to use the second set of devices in spite of the predicted energy consumption peak. For example, as explained earlier herein, the user may be relying on the grid, as well as the solar energy system to power the second set of devices. In that case, the user may decide that it is important to keep those devices functioning even if the energy consumption peak will cause an increase in the user's energy cost from the grid.

Accordingly, if the user decides not to shift the time of use of the second set of devices, then the user may generate, or initiate, a second user implemented override signal, which will effectively override the generation of the shift signal. In other words, the user implemented second override signal would prevent the App. 100 from sending a shift signal and keep the second set of devices functioning during the predicted energy consumption peak period.

However, the user may decide not to generate the second user implemented override signal. In that case the shift signal will be generated by the App. 100 to shift the time of use of the second set of devices during the predicted energy consumption peak period.

Alternatively, rather than generating a second user implemented override signal, the App. 100 may shift the time of use of the second set of devices by simply advising the user to manually shift the time of the user's use of the second set of devices during the predetermined time period, such that the second set of devices are not used when the one or more energy consumption peaks are predicted to occur. This is the example depicted in FIG. 2, wherein a speaker 102 connected to the App. 100 verbally indicates at 110 that the second set of devices should be deferred (in the example of FIG. 2 “to 3 PM”), because, “based on the consumption pattern,” an energy consumption peak is about to occur.

In the example illustrated in FIG. 2, the second set of devices include loads 3, 5 and 6 and the living room. However, any number of devices that are connected to the solar energy system may be included in the second set of devices.

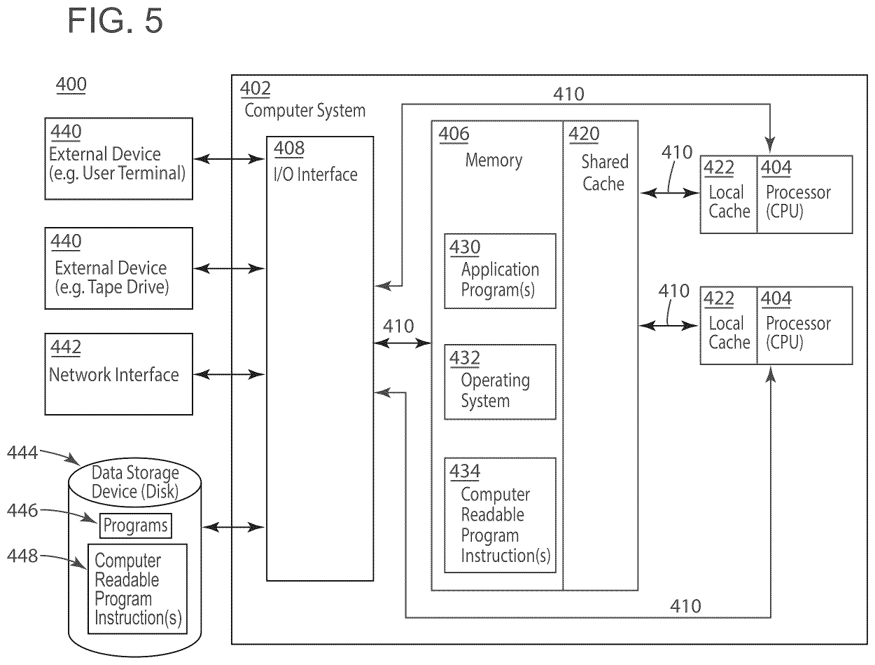

Referring to FIG. 5 an example is depicted of a computing environment which may be used to incorporate and perform one or more aspects of a method for managing solar energy consumption of a user, in accordance with aspects described herein.

FIG. 5 represents one example of a computer system that includes processors that may be used by one or more aspects of the present invention. In this example, the computer system is part of a computing environment including additional components that may or may not be used by aspects of the present invention.

As shown in FIG. 5, a computing environment 400 useable to perform the process of this invention is disclosed. The computing environment includes, for instance, a computer system 402 shown, e.g., in the form of a general-purpose computing device. Computer system 402 may include, but is not limited to, one or more processors or processing units 404 (e.g., central processing units (CPUs)), a memory 406 (a.k.a., system memory, main memory, main storage, central storage or storage, as examples), and one or more input/output (I/O) interfaces 408, coupled to one another via one or more buses and/or other connections 410.

Bus 410 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 406 may include, for instance, a cache 420, such as a shared cache, which may be coupled to local caches 422 of processors 404. Further, memory 406 may include one or more programs or applications 430, an operating system 432, and one or more computer readable program instructions 434. Computer readable program instructions 434 may be configured to carry out functions of embodiments of aspects of the invention.

Computer system 402 may also communicate via, e.g., I/O interfaces 408 with one or more external devices 440, one or more network interfaces 442, and/or one or more data storage devices 444. Example external devices include a user terminal, a tape drive, a pointing device, a display, etc. Network interface 442 enables computer system 402 to communicate with one or more networks, such as a local area network (LAN), a general wide area network (WAN), and/or a public network (e.g., the Internet), providing communication with other computer devices or systems. For example, the system may be connected to a personal computer, tablet device or smartphone to communicate the assigned or unassigned status of mobile objects to user via a graphical user interface.

Data storage device 444 may store one or more programs 446, one or more computer readable program instructions 448, and/or data, etc. The computer readable program instructions may be configured to carry out functions of embodiments of aspects of the invention.

Computer system 402 may include and/or be coupled to removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 402. Examples, include, but are not limited to: microcode, device drivers, redundant processing units, external disk drive arrays, RAID systems, tape drives, and data archival storage systems, etc.

Computer system 402 may be operational with numerous other general purpose or special purpose computing system environments or configurations. Examples of well-known computing systems, environments, and/or configurations that may be suitable for use with computer system 402 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

One or more of the processors and/or other aspects of the computer system or computing environment may be remote from the mobile object. Further, in one particular example, a processor, such as processor 404, may execute, in accordance with one or more aspects of the present invention, one or more machine learning engines and/or other engines to provide, based on training and learning, an optimal travel route or path for mobile object. These engines may be stored in memory, including main memory and/or one or more caches, and/or external storage, and may be executed on one or more processors. Many variations exist.

One or more aspects of the present invention are inextricably tied to computer technology and/or to the improvement of a technical field.

One or more aspects may relate to cloud computing. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

### Service Models are as Follows:

Software as a Service (Saas): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

Aspects of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages such as Python, Angular, HTML, CSS, .NET Framework, C# and Microsoft SQL Server, and including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, different types of unmanned aerial vehicles may be used, as well as other types of neural networks and/or evolutionary algorithms. Many variations are possible.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Although the invention has been described by reference to specific examples, it should be understood that numerous changes may be made within the spirit and scope of the inventive concepts described. Accordingly, it is intended that the disclosure not be limited to the described examples, but that it has the full scope defined by the language of the following claims.

What is claimed is:

1. A computer implemented method for managing solar energy consumption of a user, the method comprising:
retrieving weather data over a predetermined time period from weather resources connected to the internet;
obtaining solar energy generation ratings of a solar energy system of a user;
forecasting a solar energy peak generation profile over the predetermined time period for the solar energy system based on the weather data and the solar energy generation ratings;
obtaining energy consumption ratings of a plurality of devices used by the user that are connected to, and powered by, the solar energy system;
determining an energy consumption pattern of the user's use of the plurality of devices over the predetermined time period;
predicting, during the predetermined time period, when one or more offshoots of the energy consumption pattern will occur, wherein the energy consumption pattern will exceed the forecasted solar energy peak generation profile; and
avoiding the one or more offshoots of the energy consumption pattern by first modifications of the user's use of a first set of devices of the plurality of devices during the predetermined time period, wherein the avoiding results in a reduction of energy consumption costs or a reduction in CO2 emissions.

2. The computer implemented method of claim 1, wherein the avoiding the one or more offshoots comprises:
prohibiting the user's use of the first set of devices when the one or more offshoots are predicted to occur.

3. The computer implemented method of claim 2, wherein the prohibiting comprises:
notifying the user that a disconnect signal to automatically disconnect the first set of devices from the solar energy system is about to be generated;
overriding the generation of the disconnect signal via generation of a first user implemented override signal, if the user decides not to disconnect the first set of devices; and
generating the disconnect signal, if the first user implemented override signal is not generated.

4. The computer implemented method of claim 2, wherein the prohibiting comprises:
advising the user to manually disconnect the first set of devices from the solar energy system when the one or more offshoots are predicted to occur.

5. The computer implemented method of claim 1, comprising:
predicting, during the predetermined time period, when one or more energy consumption peaks of the energy consumption pattern will occur; and
reducing the one or more energy consumption peaks of the energy consumption pattern by second modifications of the user's use of a second set of devices of the plurality of devices during the predetermined time period, wherein the reducing results in a further reduction of energy consumption costs or a further reduction in CO2 emissions.

6. The computer implemented method of claim 5, wherein the reducing the one or more energy consumption peaks comprises:
shifting the time of the user's use of the second set of devices during the predetermined time period, such that the second set of devices are not used when the one or more energy consumption peaks are predicted to occur.

7. The computer implemented method of claim 6, wherein the shifting the time of the user's use comprises:
notifying the user that a shift signal to automatically shift the time of the user's use of the second set of devices during the predetermined time period is about to be generated;
overriding the generation of the shift signal via generation of a second user implemented override signal, if the user decides not to shift the user's use of the second set of devices; and
generating the shift signal, if the second user implemented override signal is not generated.

8. The computer implemented method of claim 6, wherein the shifting the time of the user's use comprises:
advising the user to manually shift the time of the user's use of the second set of devices during the predetermined time period, such that the second set of devices are not used when the one or more energy consumption peaks are predicted to occur.

9. A computer system for managing solar energy consumption of a user comprising:
at least one memory; and
one or more processors in communication with the at least one memory, wherein the computer system is configured to perform a method, the method comprising:
retrieving weather data over a predetermined time period from weather resources connected to the internet,
obtaining solar energy generation ratings of a solar energy system of a user,
forecasting a solar energy peak generation profile over the predetermined time period for the solar energy system based on the weather data and the solar energy generation ratings,
obtaining energy consumption ratings of a plurality of devices used by the user that are connected to, and powered by, the solar energy system,
determining an energy consumption pattern of the user's use of the plurality of devices over the predetermined time period,
predicting, during the predetermined time period, when one or more offshoots of the energy consumption pattern will occur, wherein the energy consumption pattern will exceed the forecasted solar energy peak generation profile,
avoiding the one or more offshoots of the energy consumption pattern by first modifications of the user's use of a first set of devices of the plurality of devices during the predetermined time period, wherein the avoiding results in a reduction of energy consumption costs or a reduction in CO2 emissions.

10. The computer system of claim 9, wherein the avoiding the one or more offshoots comprises:
prohibiting the user's use of the first set of devices when the one or more offshoots are predicted to occur.

11. The computer system of claim 10, wherein the prohibiting comprises:
notifying the user that a disconnect signal to automatically disconnect the first set of devices from the solar energy system is about to be generated;
overriding the generation of the disconnect signal via generation of a first user implemented override signal, if the user decides not to disconnect the first set of devices; and
generating the disconnect signal, if the first user implemented override signal is not generated.

12. The computer system of claim 10, wherein the prohibiting comprises:
advising the user to manually disconnect the first set of devices from the solar energy system when the one or more offshoots are predicted to occur.

13. The computer system of claim 9, comprising:
predicting, during the predetermined time period, when one or more energy consumption peaks of the energy consumption pattern will occur; and
reducing the one or more energy consumption peaks of the energy consumption pattern by second modifications of the user's use of a second set of devices of the plurality of devices during the predetermined time period, wherein the reducing results in a further reduction of energy consumption costs or a further reduction in CO2 emissions.

14. The computer system of claim 13, wherein the reducing the one or more energy consumption peaks comprises:
shifting the time of the user's use of the second set of devices during the predetermined time period, such that the second set of devices are not used when the one or more energy consumption peaks are predicted to occur.

15. The computer system of claim 14, wherein the shifting the time of the user's use comprises:
notifying the user that a shift signal to automatically shift the time of the user's use of the second set of devices during the predetermined time period is about to be generated;
overriding the generation of the shift signal via generation of a second user implemented override signal, if the user decides not to shift the user's use of the second set of devices; and
generating the shift signal, if the second user implemented override signal is not generated.

16. The computer system of claim 14, wherein the shifting the time of the user's use comprises:
advising the user to manually shift the time of the user's use of the second set of devices during the predetermined time period, such that the second set of devices are not used when the one or more energy consumption peaks are predicted to occur.

17. A computer system product for managing solar energy consumption of a user, the computer system product comprising:
at least one computer readable storage medium readable by a processing circuit and storage instructions for performing a method comprising:
retrieving weather data over a predetermined time period from weather resources connected to the internet,
obtaining solar energy generation ratings of a solar energy system of a user,
forecasting a solar energy peak generation profile over the predetermined time period for the solar energy system based on the weather data and the solar energy generation ratings,
obtaining energy consumption ratings of a plurality of devices used by the user that are connected to, and powered by, the solar energy system,
determining an energy consumption pattern of the user's use of the plurality of devices over the predetermined time period,
predicting, during the predetermined time period, when one or more offshoots of the energy consumption pattern will occur, wherein the energy consumption pattern will exceed the forecasted solar energy peak generation profile,
avoiding the one or more offshoots of the energy consumption pattern by first modifications of the user's use of a first set of devices of the plurality of devices during the predetermined time period, wherein the avoiding results in a reduction of energy consumption costs or a reduction in CO2 emissions.

18. The computer system product of claim 17, wherein the avoiding the one or more offshoots comprises:
prohibiting the user's use of the first set of devices when the one or more offshoots are predicted to occur.

19. The computer system product of claim 18, wherein the prohibiting comprises:
notifying the user that a disconnect signal to automatically disconnect the first set of devices from the solar energy system is about to be generated;
overriding the generation of the disconnect signal via generation of a first user implemented override signal, if the user decides not to disconnect the first set of devices; and
generating the disconnect signal, if the first user implemented override signal is not generated.

20. The computer system product of claim 18, wherein the prohibiting comprises:
advising the user to manually disconnect the first set of devices from the solar energy system when the one or more offshoots are predicted to occur.

21. The computer system product of claim 17, comprising:
predicting, during the predetermined time period, when one or more energy consumption peaks of the energy consumption pattern will occur; and
reducing the one or more energy consumption peaks of the energy consumption pattern by second modifications of the user's use of a second set of devices of the plurality of devices during the predetermined time period, wherein the reducing results in a further reduction of energy consumption costs or a further reduction in CO2 emissions.

22. The computer system product of claim 21, wherein the reducing the one or more energy consumption peaks comprises:
shifting the time of the user's use of the second set of devices during the predetermined time period, such that the second set of devices are not used when the one or more energy consumption peaks are predicted to occur.

23. The computer system product of claim 22, wherein the shifting the time of the user's use comprises:
notifying the user that a shift signal to automatically shift the time of the user's use of the second set of devices during the predetermined time period is about to be generated;
overriding the generation of the shift signal via generation of a second user implemented override signal, if the user decides not to shift the user's use of the second set of devices; and
generating the shift signal, if the second user implemented override signal is not generated.

24. The computer system product of claim 22, wherein the shifting the time of the user's use comprises:
advising the user to manually shift the time of the user's use of the second set of devices during the predetermined time period, such that the second set of devices are not used when the one or more energy consumption peaks are predicted to occur.
